(19) United States
(12) Patent Application Publication
(10) Pub. No.: US 2004/0237042 A1
(43) Pub. Date: Nov. 25, 2004

(54) System and method for collectively managing information technology resources

(75) Inventors: Bryan P. Murray, Duvall, WA (US); Nicolas Catania, Palo Alto, CA (US); M. Homayoun Pourheidari, Mountain View, CA (US); Guillaume N. Vambenepe, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/445,157

(22) Filed: May 23, 2003

(51) Int. Cl. G06F 17/21

(52) U.S. Cl. 715/530

(57) ABSTRACT

A system for managing an information technology (IT) resource comprises a managed object that represents a particular resource. At least one interface is associated with the managed object. The managed object is configured to receive a request from a manager; forward the request to a group of managed objects specified by the request; gather responses to the request from the group of managed objects; and transmit the responses from the group of managed objects to the manager in a single response.

### RELATED APPLICATIONS

The disclosed system and operating method are related to subject matter disclosed in (1) U.S. patent application Ser. No. ______, (Attorney Docket No. 200311917-1) entitled “System and Method for Discovering Managed Information Technology Resources”; and (2) U.S. patent application Ser. No. ______, entitled “System and Method for Managing Web Services”, (Attorney Docket No. 200309897-1), which are incorporated by reference herein in their entirety:

### COMPUTER PROGRAM LISTING APPENDIX

This specification includes Appendix A (consisting of five text files) on CD-ROM, which contains interface description documents that can be used with some embodiments of the invention. Appendix A is incorporated herein by reference.

### BACKGROUND

Today, information technology (IT) resources are managed using a variety of incompatible and often proprietary interfaces and protocols. Requirements for management information regarding the resources need to be specifically programmed to address new resources and in many cases the specific programming is not updated as new versions of the IT resources become available.

The problem of managing disparate IT resources is becoming more acute as systems are increasingly developed using IT resources that are deployed in remote locations and accessed via information networks, such as the Internet. Generally, the resources to be managed are not readily identifiable when the resources are highly distributed and independent of one another. Further, it is difficult to obtain information regarding properties and attributes of the resources, and protocols for exchanging management information with the resources. A further difficulty lies in determining the relationships among the resources used in a system to pinpoint operational problems when one or more of the resources do not respond as expected.

The term Web services, also referred to herein as “services”, describes an approach to distributed computing in which interactions are carried out through the exchange of eXtensible Markup Language (XML) messages. Web services can perform any task that can be described and contained within one or more modules of code. Essentially any transaction or bit of business logic can become a Web service if it can be accessed and used by another system over the Internet.

A Web service is a software system identified by a Universal Resource Identifier (URI) whose public interfaces and bindings are typically defined and described in an XML document. The description can be discovered by other software systems. These systems may then interact with the Web service in a manner prescribed by its definition, using XML based messages conveyed by Internet protocols.

The Web services architecture is based upon the interactions between three primary roles: service provider, service registry, and service requester. These roles interact using publish, find and bind operations. The service provider is the entity that provides access to the Web service and publishes the service description in a service registry. The service requestor finds the service description in a service registry and can use the information in the description to bind to a service.

Web services typically send XML messages formatted in accordance with the Simple Object Access Protocol (SOAP) specification. The SOAP specification is a universally agreed-upon protocol that can use XML and HTTP together to invoke functions exposed in Web services.

The XML messages are described using the Web Services Description Language (WSDL) specification, which, along with the Universal Description Discovery and Integration (UDDI) registry, provides a definition of the interface to a Web service and identifies service providers in a network. The WSDL specification is an XML-based language used to define Web services and describe how to access them. An application trying to use a particular Web Service can often use WSDL to find the location of the Web service, the operations available, and the format that must be followed to access the Web service. Therefore, the client first obtains a copy of the WSDL file from the server and then uses the information in this file to format a SOAP request.

The UDDI registry supports Web services by providing a place for a company to register its business and the Web services that it offers. Users that need a Web service can use this registry to find a business that provides the service.

It is not uncommon for systems that manage IT resources to be responsible for monitoring and/or controlling hundreds or even thousands of resources. Current systems do not provide a common, consistent facility for accessing management features of the IT resources. Further, the systems do not allow a manager to issue a request to all, or a selected subset, of the resources being managed via a single request.

### SUMMARY

In one embodiment, a system for managing an information technology (IT) resource comprises a managed object that represents a particular resource. At least one interface is associated with the managed object. The managed object is configured to receive a request from a manager; forward the request to a group of managed objects specified by the request; gather responses to the request from the group of managed objects; and transmit the responses from the group of managed objects to the manager in a single response.

In another embodiment, a computer product comprises a managed object executable on a computer processor. A managed object interface associated with the managed object is configured to dynamically provide a list of members of a group of managed objects to a manager via the managed object interface. The managed object also issues a request from the manager to members of the group of managed objects, and transmits responses from the group of managed objects to the manager in a single response via the managed object interface.

In yet another embodiment, a method for managing an IT resource comprises configuring the resource with a management interface; receiving a request from a manager to the resource, wherein the request indicates resources selected to receive the request; and transmitting the request to the selected resources.

Various other features of embodiments of the invention will be more fully understood upon consideration of the detailed description below, taken together with the accompanying figures.

### BRIEF DESCRIPTION OF THE FIGURES

FIG. 1A is a diagram of components included in an embodiment of an information technology (IT) resource management system.

FIG. 1B is a diagram showing additional components included in an embodiment of the information technology (IT) resource management system of FIG. 1A.

FIG. 2 is a diagram showing further detail of an embodiment of a portion of the management interfaces of FIG. 1B.

FIG. 3 is a diagram showing further detail of an embodiment of another portion of the management interfaces of FIG. 1B.

FIG. 4 is a diagram showing further detail of an embodiment of yet another portion of the management interfaces of FIG. 1B.

FIGS. 5 and 6 show diagrams of four independent entities capable of coordinating distributed Web services that can be monitored by a manager.

FIGS. 7 through 12 show diagrams of the distributed processing system of FIGS. 5 and 6 with annotations of various processes performed by RFQ process and auction manager.

### DETAILED DESCRIPTION OF THE FIGURES

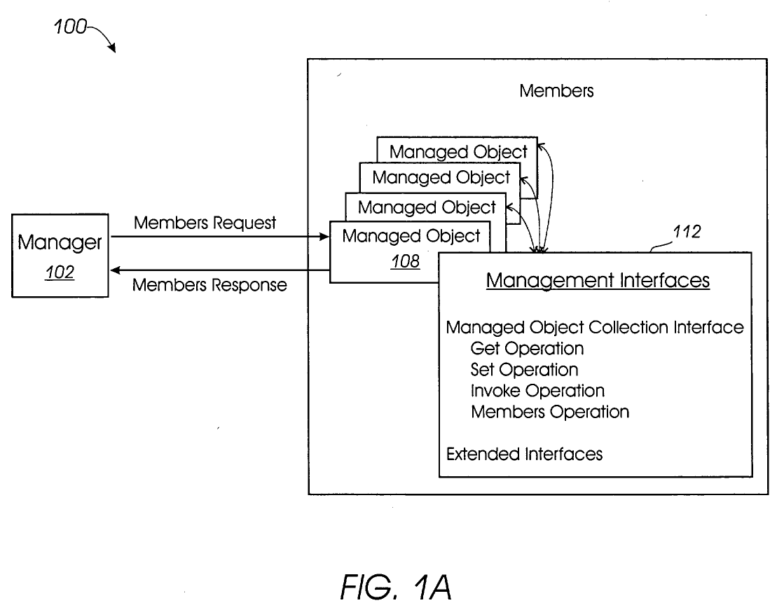

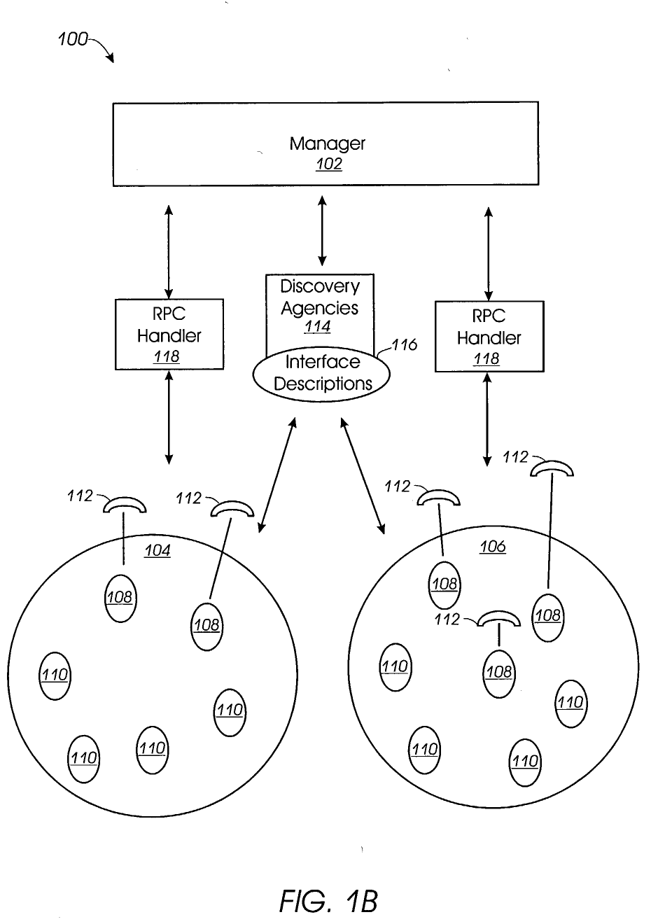

Referring now to FIGS. 1A and 1B, an embodiment of a management system 100 that allows manager 102 to monitor and control information technology (IT) resources in one or more domains 104, 106 is shown. The resources can be any type of software, hardware, and/or firmware that is configured to interface with manager 102. Resources that are configured to interface with manager 102 are represented by managed objects 108. Resources that are not configured to interface with manager 102 are represented by unmanaged objects 110.

Management system 100 includes features that provide a common, consistent facility for accessing management features of managed objects 108. Manager 102 can issue a request to all, or a selected group of managed objects 108 via a single request to one of managed objects 108, as indicated in FIG. 1A. The responses to the request from managed objects 108 can be aggregated and returned to manager 102 via a single response.

In some embodiments, the features that help streamline communications between manager 102 and managed objects 108 are provided via Managed Object Colletion Interface in management interfaces 112 of one of managed objects 108. As further described herein, features such as Get and Set Operations can be provided to allow manager 102 to query and modify the value of one or more attributes in each of managed objects 108. Other features such as an Invoke Operation can be provided to allow manager 102 to invoke one or more specified operations in each of managed objects 108. Another feature such as a Members attribute can be provided to allow manager 102 to determine the members in a specified collection. Other features can be included in Managed Object Colletion Interface and in other facilities in management system 100 to streamline communications between manager 102 and managed objects 108, as well as between managed objects 108.

Management interfaces 112 allow manager 102 to access information to monitor, audit, and control various aspects of resources represented by managed objects 108, and to register to receive event notifications. Manager 102 can also use information in management interfaces 112 to determine management attributes and relationships among related managed objects 108.

Managed objects 108 interface with the underlying resources to gather information to populate data fields in management interfaces 112 that are available to manager 102. Further, managed objects 108 receive information and control parameters from manager 102 via management interfaces 112.

Various implementations of management interfaces 112 can hide selected management capabilities from managers 102 that are not authorized to access the selected management capabilities. Each managed object 108 can also utilize one or more additional extended interfaces that expose relevant information to manager 102. The extended interfaces can be implemented as needed based on the type of resource to be managed.

In some embodiments, manager 102 and managed objects 108 can communicate with one or more discovery agencies 114 to access interface descriptions 116 for management interfaces 112. Interface descriptions 116 can be configured to expose some or all of the management features that are available through a particular management interface 112 to manager 102.

Interface descriptions 116 provide a common framework for exposing management services for all managed objects 108 regardless of the resources they represent. Management interfaces 112 can be implemented in various languages and formats. Interface descriptions 116 define management features available through management interfaces 112 in a common format that can be used by other managed objects 108 and manager 102. In some embodiments, interface descriptions 116 define management interfaces 112 in Web Services Description Language (WSDL), and messages between manager 102 and managed objects 108 can be exchanged via the Simple Object Access Protocol (SOAP) protocol. Other suitable formats and protocols can be used. Additionally, manager 102 can discover interface descriptions 116 and management interfaces 112 via any suitable discovery agency 114, such as UDDI, or other suitable method.

Managed objects 108 can themselves be utilized as Web services by manager 102. Web services can be document-oriented endpoints or method-oriented endpoints. The messages exchanged with a document-oriented Web service can contain an XML document, and all message semantics are application-defined. An example of document-oriented Web services is discovery agencies 114, which provide interface descriptions 116 to manager 102. With method-oriented Web services, such as managed objects 108, remote procedure call (RPC) handler 118 can be implemented to transmit and receive messages corresponding to a RPC. Message(s) pass inbound from manager 102 to one or more of managed objects 108 and contain the method identifier and any input parameters. The information in the message is used to map to a method call in the appropriate native programming language for the underlying resource, and to execute the method with the supplied input parameters. After the method executes, another message passes outbound from managed object(s) 108 to manager 102 that contains the method identifier, the result of executing the method, and any output parameters (or exception information in the case of an error).

RPC handler 118 can be included to handle messages containing responses and requests between manager 102 and managed objects 108. RPC handler 118 can alleviate the need for a developer to write, transmit, interpret, correlate messages by hand, and then map the messages to and from various native programmatic types used by the underlying resources. A common XML messaging protocol for RPCs is the Simple Object Access Protocol. In some embodiments, a Java application program interface (API) for XML-based remote procedure calls (referred to as JAX-RPC) can be used to implement RPC handler 118 and call SOAP-based Web services described by the Web Services Description Language (WSDL). Other suitable application program interfaces, programming languages, remote procedure call facilities, and protocols can be utilized to implement RPC handler 118 in addition to, or instead of, JAX-RPC and SOAP. RPC handlers 118 can be deployed as part of managed objects 108, or provided independently on a platform that can access the corresponding managed objects 108.

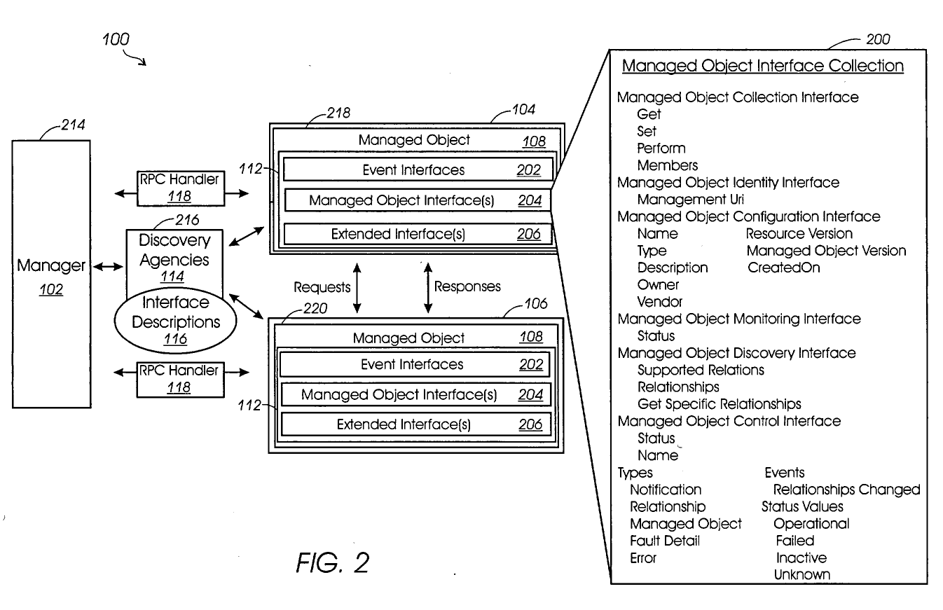

Referring now to FIG. 2, in some embodiments, management interfaces 112 include event interfaces 202, managed object interfaces 204, and extended interfaces 206. Mangement interfaces 112 typically include attributes that represent information about managed objects 108; operations to support the management of managed objects 108; and/or events representing exceptions and state changes that can be reported by managed objects 108 to manager 102. Management interfaces 112 can be implemented within managed objects 108, such as shown for managed object 108 in FIG. 2, or in a layer external to managed object 108 as shown in FIG. 1B. Similarly, managed objects 108 can be implemented internally or externally to the resources they represent.

In some embodiments, each collection of management interfaces 112 supports one or more categories of management capabilities such as monitoring, discovery, control, performance, configuration, and security. Additional or fewer categories can be utilized. Further, other interfaces that support additional or different management capabilities can be utilized, in addition to, or instead of, event interfaces 202, managed object interfaces 204, and extended interfaces 206.

Interfaces shown in the embodiment of Managed Object Interface Collection 200 of FIG. 2 include Managed Object Collection Interface, Managed Object Identity Interface, Managed Object Configuration Interface, Managed Object Monitoring Interface, Managed Object Discovery Interface, and Managed Object Control Interface.

In the embodiment shown, Managed Object Collection Interface includes Get, Set, Invoke operations, and Members attribute.

Get (select, interface, name) represents an operation used to query the value of an attribute from members of a collection of managed objects 108. Set (select, interface, name, value) represents an operation used to modify the value of an attribute on members of a collection of managed objects 108 to the specified value. Invoke (select, interface, name, arguments) represents an operation used to invoke an operation with the specified arguments on members of a collection of managed objects 108. The management interface and the name of the attribute or operation can be specified by the interface and name arguments. The select argument can be an XPath expression that identifies a subset of members of the collection. XPath is a non-XML language used to identify particular parts of XML documents. The return value can be a list of structures that include the value of the specified attribute, fault information that resulted from the query on a particular managed object 108, or result of an operation. Other suitable languages can be used in addition to, or instead of, XPath and XML.

Members represents an attribute that returns a list of the members of the collection of managed objects 108. In some embodiments, the list is a subset of the list of managed objects 108 returned from a Relationships Operation further described herein. Manager 102 can invoke the Relationships Operation to determine all of the managed objects 108 related to a particular managed object 108. Once manager 102 determines the relationships and configuration of related managed objects 108, manager 102 can group managed objects 108 into various “collections” for purposes of streamlining requests to, and responses from, two or more managed objects 108 using the operations in Managed Object Collection Interface, as well as other facilities that can be included in management system 100.

Managed objects 108 can implement Managed Object Identity Interface, which can include an attribute represented by Management URI. Management URI can return an identifier, such as a URI, for interface descriptions 116 of Managed Object Interfaces Collection 200.

Managed Object Configuration Interface can include components such as attributes regarding the configuration of associated managed object 108, for example, Name, Type, Description, Owner, Vendor, Resource Version, Managed Object Version, and Created On.

Name represents an attribute that returns the name of managed object 108. Name can be a read-write attribute, and the write portion can be handled in another interface, such as the Managed Object Control Interface, as further described herein.

Type represents an attribute that returns the type of managed object 108. The types that are available will depend on the domain and the resources being managed. For example, to manage Web services, types such as Web service, Web service execution environment, and Conversation can be utilized in some embodiments.

Description represents an attribute that returns a description of managed object 108. Manager 102 can present the description when a user requests more information regarding a particular managed object 108. The information is typically distinct from interface descriptions 116.

Owner represents an attribute that returns the owner of managed object 108. The owner can be the entity that deployed the resources underlying managed object 108. For instance, if a company has developed and deployed a resource that can be hosted on a third-party system, the company still owns the associated managed object 108. In addition, if a company has purchased the rights to use and deploy a resource locally, the company owns the resource.

Vendor represents an attribute that returns the vendor originating managed object 108.

Resource Version represents an attribute that returns the version of the underlying resource.

Managed Object Version represents an attribute that returns the version of managed object 108.

Created On represents an attribute that returns the date and time managed object 108 was created.

For example, to manage Web services, managed object 108 can support relations such as Contains, Contained In, Depends On, Depended Upon, and Corresponds To. A containing managed object can use the Contains relation to indicate its relationship with a managed object it contains. A managed object 108 contained by another managed object 108 can use the Contained In relation to indicate its relationship with the managed object 108 that contains it. A managed object 108 that depends on another managed object 108 can use the Depends On relation to indicate its relation with the managed object 108 on which it depends. A managed object 108 that can be depended upon by another managed object 108 can use the Depended Upon relation to indicate its relationship with the dependent objects. A managed object 108 can use the Corresponds To relation to indicate a peer relationship with another managed object 108. Other suitable relations can be utilized. Manager 102 can use the Get Relationships operation to discover the managed objects 108 that are linked to a certain managed object 108 by relationships.

Managed Object Monitoring Interface can include features such as a Status attribute, which represents an attribute that returns the status of managed object 108. The status can be represented as an identifier, such as a URI, for a document that includes information regarding the status of the underlying resources. Managed Object Interface Collection 200 defines basic status values, which can be supported by all managed objects 108. Other interfaces may define other status values that may be returned by the Status attribute. The read portion of the Status attribute can be in one interface such as the Managed Object Monitoring Interface, and the write portion of the Status attribute can be in another interface such as the Managed Object Control Interface. Handling the read and write portions of an attribute in different interfaces allows the owner of managed object 108 to offer read-only access to the status to one manager 102, and read-write access to the status to other managers 102.

Managed Object Discovery Interface can include features such as a Supported Relations attribute, a Relationships attribute, and a Get Specific Relationships operation. Supported Relations represents an attribute that returns a list of the relations supported by managed object 108. Any of the relations in the list may be used in relationships managed object 108 has with other managed objects. Relationships represents an attribute that returns a list of relationships that are currently active for managed object 108. The list of relationships can be dynamic and can change as the underlying resource interacts with other resources. Get Specific Relationships (relation) represents an operation that returns a list of identifiers such as URIs of relationships having a specific relation with another managed object 108. This operation typically returns a subset of the list returned by the Relationships attribute.

Managed Object Control Interface can be used to modify the state of managed object 108. In some embodiments, access to Managed Object Control Interface can be controlled via interface descriptions 116 to allow only managers 102 with acceptable privileges use Managed Object Control Interface. The embodiment of Managed Object Control Interface shown includes Status and Name attributes, which are similar to the Status and Name attributes in the Managed Object Configuration Interface. Managers 102 with access to Managed Object Control Interface can set the values for the Status and Name attributes, however.

Several types of components can be used in managed object interfaces 204. The embodiment of Managed Object Interface Collection 200 shown in FIG. 2 includes Notification, Relationship, Managed Object, Fault Detail, and Error types that can be implemented in managed object interfaces 204. Attributes in Managed Object Interface Collection 200 can support types of access by other objects, such as read and read/write. When interface descriptions 116 are implemented in WSDL, managed object interfaces 204, 114 can be mapped to ports, and access policies can be mapped to operations on attributes, as further described herein.

Notification type can be used for event notifications that can be sent to manager 102. Relationship type can describe a relationship between two or more managed objects 108. Managed Object can be a simple type based on the XML schema any URI type and points to interface descriptions 116 for a particular managed object. An element of FaultDetail type can be added to the fault detail element of all SOAP faults returned by managed object interfaces 204, and other interfaces associated with particular types of managed objects 108. Error type can describe an error. The Fault Detail element type can include one or more of the Error type elements to offer more specific information about the error.

The embodiment of Managed Object Interface Collection 200 shown also includes Status values and Events. For example, the type Relationships Changed Event can indicate an update to relationships in managed object 108. Relationships Changed Event can occur when a new relationship is added or when a previous relationship has been removed. Manager 102 can get an updated list of relationships by using the Relationships attribute in the Managed Object Discovery Interface as described herein.

With regard to Status values included in the embodiment of Managed Object Interface Collection 200 shown in FIG. 2, Operational status can indicate the underlying resource is operational and ready to process incoming messages. Failed status can indicate managed object 108 has detected a problem and the underlying resource is unable to process incoming messages. Inactive status can indicate underlying resource has terminated normally. Unknown status can indicate the state of the underlying resource is unknown.

Management system 100 defines notification syntax and processing rules to inform one or more managers 102 that an event has occurred. An event is a state change in a managed object 108. A notification can also be used to share informational events. In one embodiment, there are two interfaces that can be used to get this information in either a push mode or a pull mode. In the push mode, managed object 108 (notifier) issues a notification to the subscribers to inform them of a change of state when an event occurs. In the pull mode, the subscriber issues calls to one or more managed objects 108 to request all the notifications that happened since the last pull call.

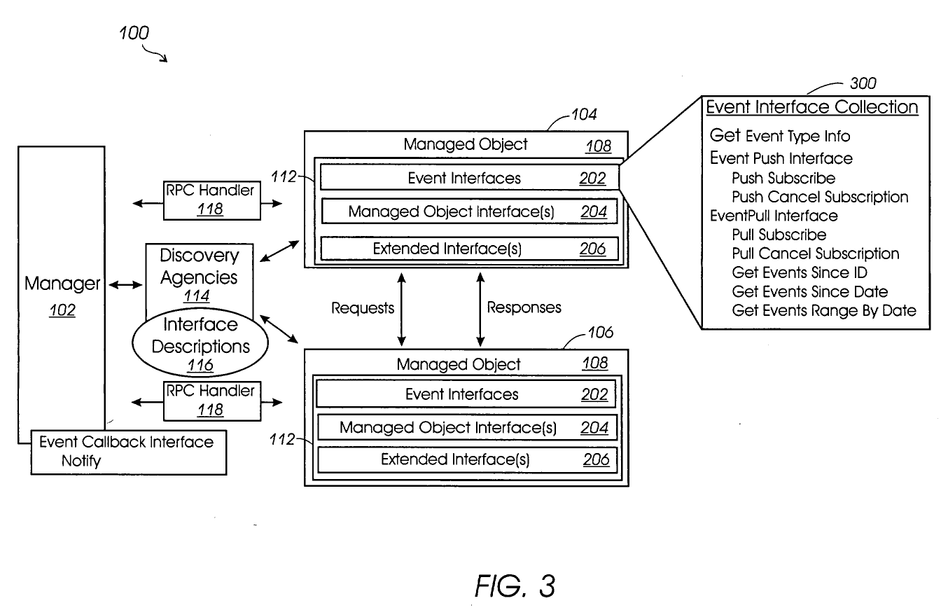

Referring to FIG. 3, management system 100 supports bulk notification operations for efficiency. For example, in the pull mode, notifications from more than one type can be retrieved through a single call. In the push mode, the subscriber can subscribe to more than one notification in one single subscribe call. Features in Managed Object Collection Interface (FIG. 1A) can be used to issue a single request for event notifications from multiple managed objects 108.

In the embodiment shown, manager 102 can subscribe to receive notification of events via one or more interfaces in Event Interface Collection 300. The embodiment of Event Interface Collection 300 shown includes a Get Event Type Info operation, Event Push Interface, Event Pull Interface, and Event Callback Interface. Get Event Type Info represents an operation that returns a list of the event types supported by managed object 108. Any of the supported events may be subscribed to in either a push or pull mode by calling the appropriate subscribe operation as further described herein.

In some embodiments, managed objects 108 can implement event Push Interface and Event Pull Interface, while Event Callback Interface can be implemented by subscribers, such as manager 102, to the events.

The embodiment of Event Push Interface shown includes Push Subscribe and Push Cancel Subscription operations. The operation Push Subscribe (EventTypes, CallbackUrl, ExpirationTime) allows manager 102 to register to receive a notification when any of a list of event types occur. The types of events available for event interface collection 300 can be determined by manager 102 via Get Event Type Info operation. In some embodiments, the return value from the Push Subscribe operation is a subscription ID.

Manager 102 can pass the subscription identifier to the Push Cancel Subscription operation to stop receiving notifications for the specified event types. The subscription can expire automatically after the expiration of a pre-specified time period. Manager 102 can invoke the Push Subscribe operation again to continue to receive event notifications.

In the embodiment of Event Pull Interface shown in FIG. 3, Pull Subscribe (EventTypes, ExpirationTime) represents an operation that allows manager 102 to subscribe to receive notifications of specified event types as requested by Manager 102. Managed object 108 can cache events of the types specified for later retrieval using operations such as: GetEventsSinceId, GetEventsSinceDate, and GetEventsRangeByDate. The types of events available for Event Interface Collection 300 can be determined by manager 102 via the Get Event Type Info operation. Pull Subscribe returns an identifier for the subscription. Manager 102 can pass the subscription identifier to the Pull Cancel Subscription operation to stop receiving notifications for the specified event types. The subscription can expire automatically after a prespecified period of time expires, at which time the specified event types will no longer be cached for that subscription. In order to continue to receive events of this type, manager 102 can re-subscribe for the desired event types.

Managed object 108 can save events for all types specified in all subscriptions. If no subscription has specified a particular event type, all events of that type may be discarded. When a subscription is cancelled or expires, the queued event types may be discarded if no other subscriptions have expressed interest in the same event types. Each implementation can specify the time period to determine when subscriptions expire and how long events are saved before they are discarded.

Pull Cancel Subscription (SubscriptionId) represents an operation that allows manager 102 to indicate the termination of interest in event types from previously registered subscriptions. The subscription identifier passed to this operation is typically the identifier returned from a previous call to Pull Subscribe.

Get Events Since Id (SubscriptionId, EventId) represents an operation that retrieves all events that have occurred since the event specified by the EventId. Only the events of the type specified by the previous subscription will be returned.

Get Events Since Date (SubscriptionId, Date) represents an operation that retrieves all events that have occurred since the specified date and time. In some embodiments, only the events of the type specified by the previous subscription will be returned.

Get Events Range By Date (SubscriptionId, StartDate, EndDate) represents an operation that retrieves all events that occurred in the specified date range. Only the events of the type specified by the previous subscription will be returned. In order to avoid missing any events, the date range can be inclusive of the endpoints.

Event Callback Interface includes Notify (notifications) operation, and can be implemented by a subscriber to push events. When managed object 108 undergoes a state change that results in one or more event to which a subscriber has registered, the managed object can invoke the Notify operation with a corresponding list of notifications. A subscriber can implement Event Callback Interface in order to receive the notifications.

Notifications are used in management system 100 to capture and correlate events from the Managed Objects 108. One or more notifications can be sent in any suitable format, such as a SOAP body. In one embodiment, the notification includes some or all of the following information:

Source, which can be any identifier that identifies the notifier;

Severity, which indicates a severity level for the notice;

Type, which classifies the notifications;

Identifier, which is a unique identifier for the notification generated;

CorrelationId, which is used to bind a set of notifications in the same context;

Timestamp, which is the time the notification was issued;

Expiration, which is the time the notification will expire;

Message, which describes the associated event; and

CorrectiveMessage, which suggests a corrective action.

Other information can be included in a notification in addition to, or instead of, one or more of the items of information described above.

In some embodiments, management system 100 supports a request/response model between manager 102 and managed objects 108, as well as between managed objects 108. In some further embodiments, if there is an error in a request or with the processing of a request, a SOAP fault message can be returned instead of the response. A SOAP fault includes a fault code, a fault string, a fault actor, and an error detail.

### Extending Management Capabilities for Managed Objects

In some embodiments, interface descriptions 116 define schemas for messages and corresponding WSDL parts; port types; marker attributes; and namespaces. Port types describe a list of potential management capabilities for manager 102. Ports that implement some or all of the port types defined in interface descriptions 116 allow managed objects 108 to expose their management capabilities and provide manager 102 with instructions for using the management capabilities. Managed objects 108 can expose different portions of the management interfaces to different managers 102. An example of WSDL interface descriptions 116 suitable for use with some embodiments of Managed Object Interface Collection 200 described herein are provided in the Appendix filed with this disclosure.

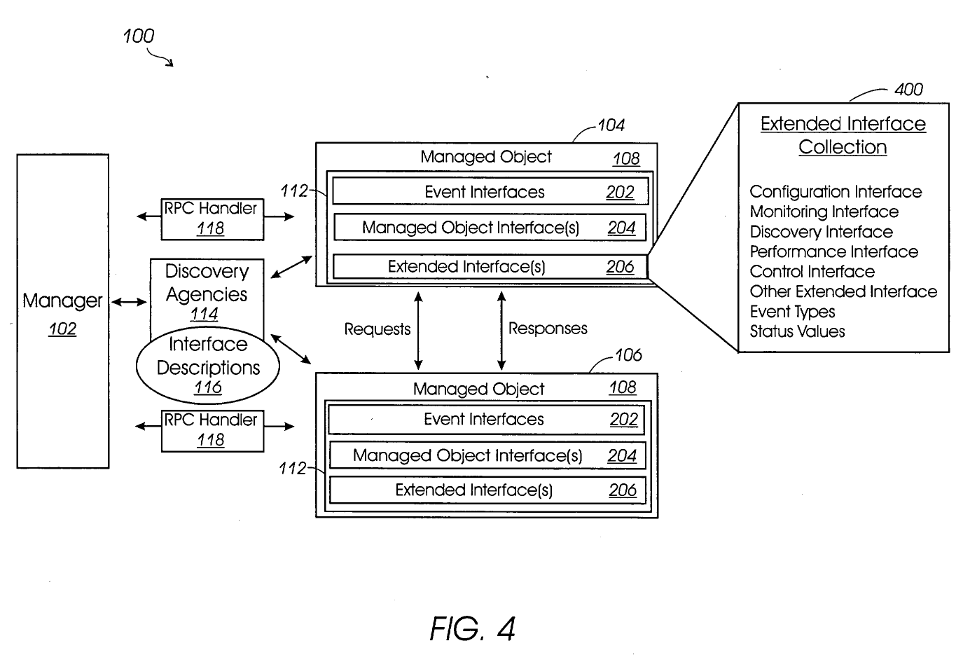

Referring to FIG. 4, extended interfaces 206 can be implemented to extend event interfaces 202 and managed object interfaces 204 to manage additional aspects of respective managed objects 108. In some embodiments, marker attributes can indicate new management port types that have been implemented in corresponding interface descriptions 116 to expose additional management aspects of managed objects 108.

Port types can describe a list of potential management capabilities for Manager 102. By making ports available that implement some or all of the port types defined in corresponding interface descriptions 116, managed objects 108 can expose their management capabilities and provide manager 102 with instructions to use the management capabilities.

Managed object 108 is not required to expose the same management interfaces 112 to all callers. It is anticipated that many managed objects 108 will expose different features in management interfaces 112 to different requesters, such as:

limiting anonymous managers 102 to only query basic information;

allowing recognized managers 102 to also query performance information; and

allowing trusted managers 102 (e.g., administrators) access to all features in management interfaces 112.

Managed objects 108 can implement selected management port types. Management port types can be derived from management interfaces 112 as follows:

a) A specific namespace corresponds to each interface collection, such as Extended Interface Collection 400, that extends the management features for managed object 108 beyond the features available in event interfaces 202 and managed object interfaces 204.

b) Inside each Extended Interface Collection 400, all attributes, operations and notifications are assigned to an interface category.

c) For each Interface Collection 200 (FIG. 2), 300 (FIG. 3), 400 (FIG. 4):

i) for each attribute with read (R) access, a get operation can be created that takes an empty input message and returns the attribute;

ii) for each attribute with write (W) access, a set operation can be created that takes the attribute and returns an empty input message;

iii) for each operation, a WSDL operation can be created with the same signature.

In some embodiments, a marker attribute can be added to the port types to indicate to manager 102 that the port types are management port types. Note that extended interface collection 400 can use none, some, or all of the interface categories shown, as well as other categories of interfaces. Additionally, various status values and event types can be defined in extended interface collection 400 that pertain to the management of resources underlying managed object 108.

To extend resource management system 100 (FIG. 1A) by defining a new relation, an identifier such as a URI to represent the new relation and an operation to follow the relation can be created in some embodiments. The Relation attribute to the operation can be defined to indicate that the operation corresponds to the newly defined relationship by setting the value of the attribute to the identifier representing the relation. For example, suppose a company defines a new relation called “like” and assigns to it the URI “http://mycompany.com/relations/like”; the following segment describes how the Relation attribute can be used to express the fact that the “GetServicesLike” operation corresponds to the following “like” relation:

```
<myns:portType name=“myPortType”>
  <operation name=“getServicesILike”
    wsmf:relation=“http://mycompany.com/relations/like”>
  (. . .)
  </operation>
</myns:portType>
```

When an operation is marked with the Relation attribute, the operation typically returns a list of managed objects 108. The list of managed objects 108 can be the same as returned by the GetRelationships operation in managed object interface 204 with the exception of managed objects 108 that do not correspond to the relation designated by the Relation attribute.

Other examples of types of extended interfaces are described in the disclosure entitled “System and Method For Managing Web Services,” U.S. application Ser. No. ______ (Attorney Docket No. 200309897-1).

### Discovery Mechanisms

Referring again to FIG. 2, management system 100 can utilize a discovery mechanism to discover managed object interfaces 204 of a managed object 108. The discovery mechanism typically does not retrieve management interface information for managed object 108 from a central point. Using interface descriptions 116 formatted in WSDL as an example, the Managed Object Identity Interface of managed object interfaces 204 can return a URI or other suitable identifier that points to the location of a WSDL document in interface descriptions 116. The WSDL document can be the root of a tree that includes all management interfaces 112 (intended for the recipient of the pointer), where nodes in the tree may be joined via elements included in the WSDL document; WSDL import statements. Once the complete document has been assembled, the resulting set of elements can include one or more services that contain one or more ports implementing at least one port type. Further embodiments for a discovery mechanism for management system 100 are described in U.S. patent application Ser. No. ______ (Attorney Docket No. 200311917-1) entitled “System and Method for Discovering Managed Information Technology Resources.” Examples of WSDL interface descriptions 116 that can be utilized with some embodiments of management system 100 are provided in the Appendix filed with this disclosure.

### Distributed Business Processes Example

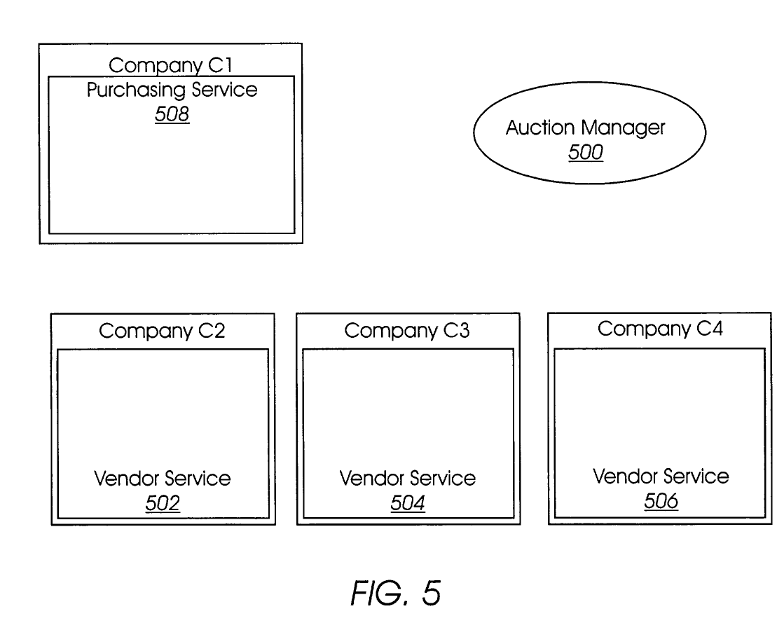

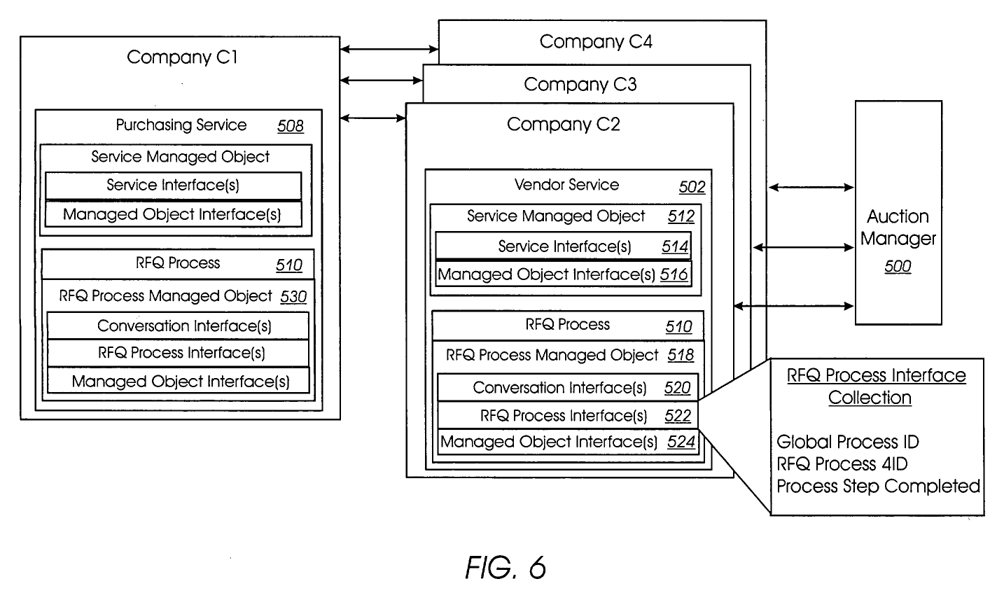

As an example of the use of management interfaces 112 (FIG. 2) to provide a common, consistent facility for accessing management features of managed objects 108 and allow manager 102 to issue a request to all, or a selected subset, of managed objects 108 via a single request, FIGS. 5 and 6 show diagrams of distributed business processes with four independent Web services that can be monitored by auction manager 500. Companies C2, C3, and C4 provide vendor services 502, 504, 506 to bid on items specified in requests for quotes (RFQs) from purchasing service 508 at Company C1. The distributed process of submitting and responding to the RFQs is shown as RFQ Process 510 in FIG. 6.

Auction manager 500 offers a management service that monitors the progress of RFQ Process 510. The business logic and operational processes are performed through purchasing service 508 at Company C1 and vendor service objects 502, 504, 506 from Companies C2, C3, and C4, respectively.

Auction manager 500 has an agreement with Companies C1, C2, C3, and C4 in which auction manager 500 defines RFQ process 510 for Company C1's purchasing service 508 to submit the RFQ, and for Companies C2, C3, and C4 to respond to the RFQ. In one embodiment, RFQ process 510 is implemented in the Business Processes Execution Language (BPEL). BPEL is an XML-based language designed to enable task sharing for a distributed computing environment, even across multiple organizations, using a combination of Web services. A developer formally describes a business process that will take place across the Web in such a way that any cooperating entity can perform one or more steps in the process the same way. In a supply chain process, for example, a BPEL program might describe a business protocol that formalizes the pieces of information in a product order, and the exceptions that may have to be handled. Other suitable specifications for implementing RFQ process 510 can be utilized, in addition to, or instead of, BPEL.

Auction manager 500 monitors RFQ process 510, which choreographs the flow of messages for the bidding until the bidding terminates. Vendor service 502, which is also representative of vendor services 504 and 506, includes service managed object 512 with service interfaces 514 and managed object interfaces 516. Vendor service 502 also includes RFQ process 510, with RFQ process managed object 518, conversation interfaces 520, RFQ process interfaces 522, and managed object interfaces 524. Managed object interfaces 524 include information regarding RFQ process 510, including the relationship of RFQ process 510 with respect to vendor service 502. Companies C2, C3, and C4 each provide auction manager 500 with a URI pointing to interface descriptions (not shown) for vendor services 502, 504, 506.

RFQ process interface 522 can be an extension to conversation interfaces 520. RFQ process 510 can therefore use attributes, operations, status values, and notifications defined in conversation interfaces 520 and managed object interfaces 524, as well as the extensions defined specifically for RFQ process 510. For purposes of this example, assume RFQ process interfaces 522 includes the following elements:

Get Global Process ID operation, which returns the global process ID (URI) for an instance of RFQ process 510. In some embodiments, the global process ID is the URI contained in the Context/Identifier element defined by WS-Coordination, which is a known framework for coordinating distributed application programs that form Web services. Other suitable identifiers can be used.

Get RFQ Process 4ID operation, which returns the URI for a description of managed object interfaces 520, 522, 524 for the specific global process ID returned from the GetGlobalProcessID operation.

Process Step Completed notification, which issues an event notification to subscribing auction managers 500 when specified portions of each RFQ process 510 are completed.

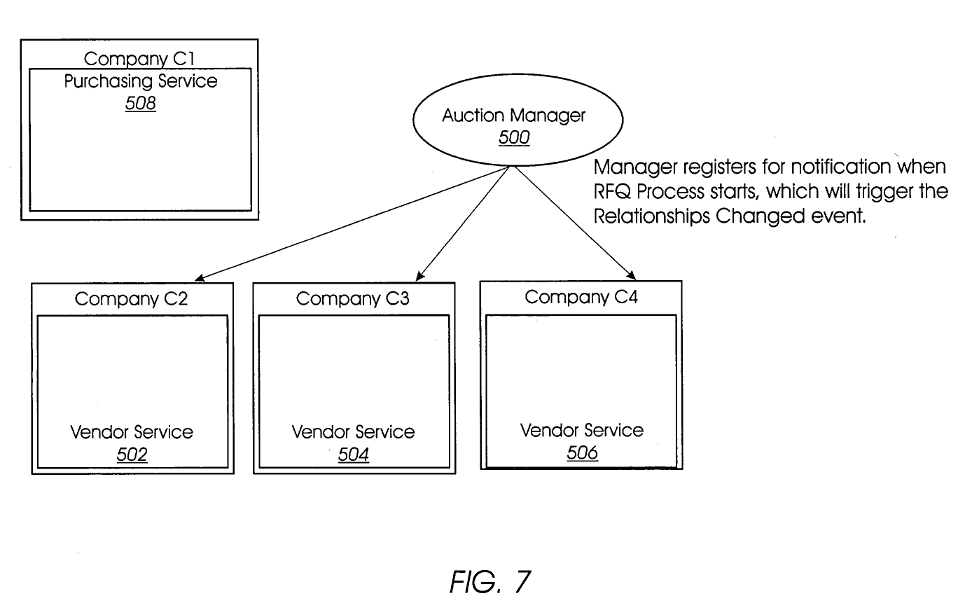

FIGS. 7 through 12 show diagrams of the distributed services of FIGS. 5 and 6 with annotations of various processes performed throughout the bidding process. In FIG. 7, auction manager 500 uses the identifier pointing to management object interface descriptions (not shown) that were provided by vendor services 502, 504, 506. Auction manager 500 registers for notification with vendor service managed object 512 (FIG. 6) using the Relationships Changed event notification in managed object interfaces 516 (FIG. 6).

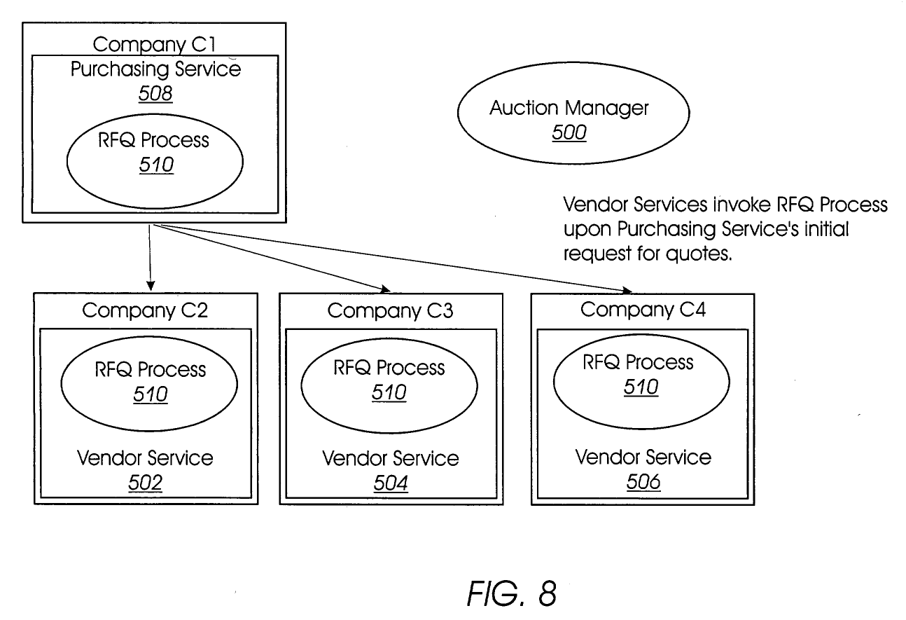

Referring to FIG. 8, purchasing service 508 knows that RFQ process 510 is available to buy selected items at a competitive price from participating vendors, such as Companies C2, C3, and C4. Purchasing service object 508 knows that auction manager 500 is available to monitor RFQ process 510, but does not necessarily know the identity of auction manager 500.

Based on the description of RFQ process 510, purchasing service 508 sends a RFQ document to vendor services 502, 504, and 506. Upon receiving the RFQ document, vendor services 502, 504, 506 invoke RFQ process 510, as shown in FIG. 8.

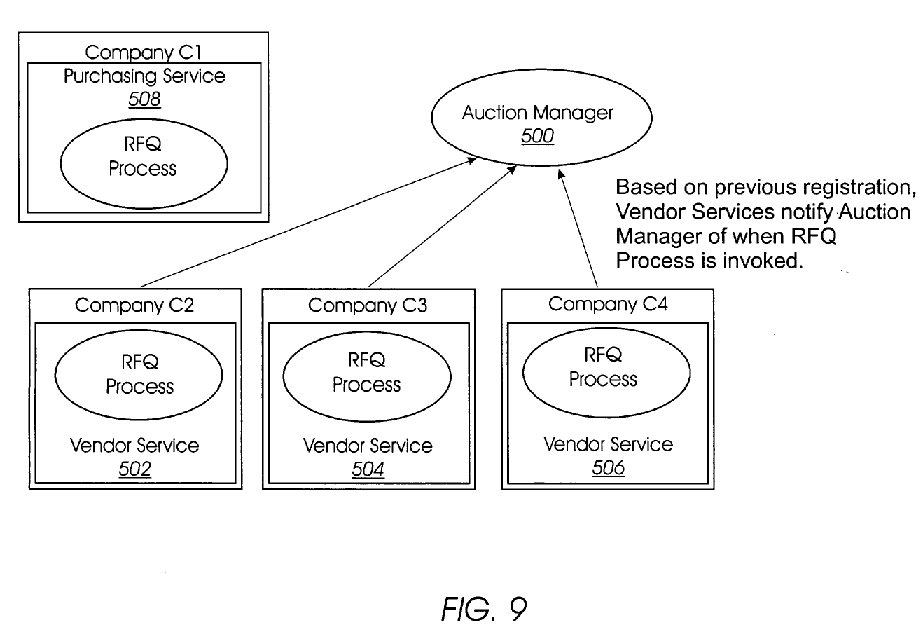

Referring to FIGS. 6 and 9, vendor services 502, 504, 506 send a notification to auction manager 500 when RFQ processes 510 begin executing. The notification includes a link to managed object interfaces 524. When the notification arrives, auction manager 500 retrieves a description of managed object interfaces 524 for RFQ process 510 using information in the notification. The interface description defines interfaces 520, 522, 524 for auction manager 500. Auction manager 500 discovers related service managed objects 512 via the Relationship attribute in managed object interfaces 524. Auction manager 500 can then invoke the management features for RFQ process 510 in RFQ process interfaces 522, as well as in managed object interfaces 524, service interfaces 514, managed object interfaces 516, and conversation interfaces 520.

Auction manager 500 can then call the Get Global Process ID operation in RFQ interfaces 522 for each RFQ process 510. The Get Global Process ID operation returns the same global ID for RFQ process 510, thus allowing the Auction Manager 500 to logically represent the separate instances of RFQ process 510 as the same process. In some embodiments, auction manager 500 utilizes bulk operations such as the Get, Set, and Invoke Operations in Managed Object Interface Collection 200 (FIG. 2) to streamline the process of issuing requests to each instance RFQ Process 510. For example, auction manager 500 can use the Invoke Operation in Managed Object Interface Collection 200 (FIG. 2) to invoke the Get Global Process ID operation on each instance of RFQ Process 510. The bulk operations can be invoked on a managed object, such as RFQ Process Managed Object 518, if it exposes the Collection interface. RFQ Process Managed Object 518 then issues the request to all managed objects in its collection, also referred to as members, specified in the bulk request.

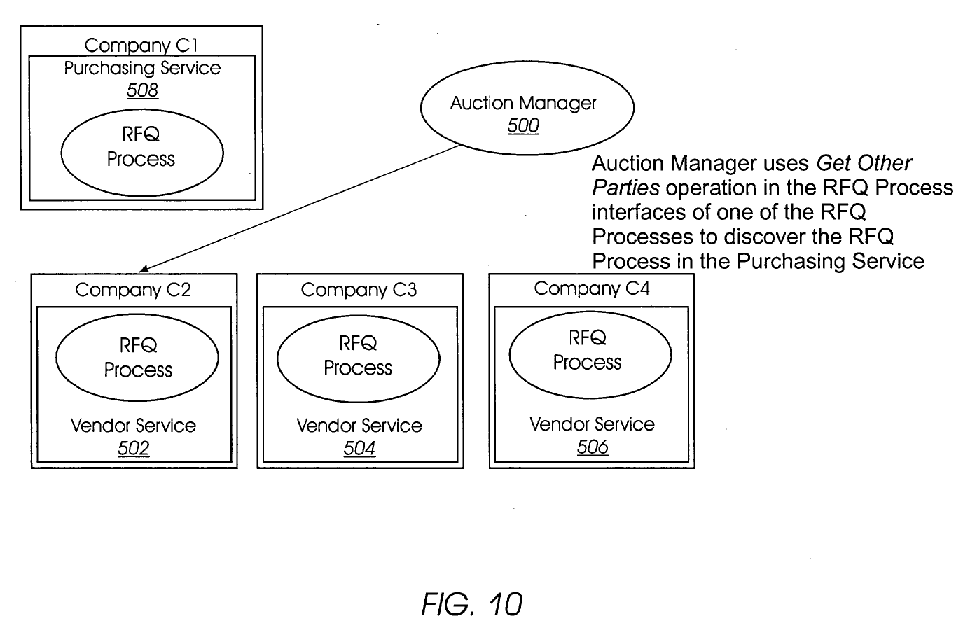

Referring to FIGS. 6 and 10, auction manager 500 invokes the Get Other Parties operation in conversation interfaces 520 for one of the three vendor companies. The Get Other Parties operation returns the identification for the three vendor services 502, 504, 506, plus purchasing service 508. Using this information, auction manager 500 retrieves a description of managed object interfaces 516 for vendor service object 502. Auction manager 500 then invokes the Get RFQ Process 4ID operation in RFQ process interfaces 522, passing the global process ID provided by the vendors C2, C3, C4. The Get RFQ Process 4ID operation returns a link to RFQ process managed object 530 for purchasing service 508 to auction manager 500.

In situations where the vendors are not aware of each other, auction manager 500 can call the Get Other Parties operation in RFQ process managed object 518, which returns IDs for each vendor service 502, 504, 506. Auction manager 500 can then call the Get RFQ Process 4ID operation in RFQ process interfaces 522 to retrieve all managed object interfaces 524 for each vendor service 502, 504, 506. In some embodiments, auction manager 500 utilizes the Invoke Operation to invoke the Get Other Parties and Get RFQ Process 4ID operations in each instance of RFQ Process 510.

At this point, discovery is complete and auction manager 500 has discovered vendor service managed objects 512 and RFQ process managed object 518 for vendor services 502, 504, 506.

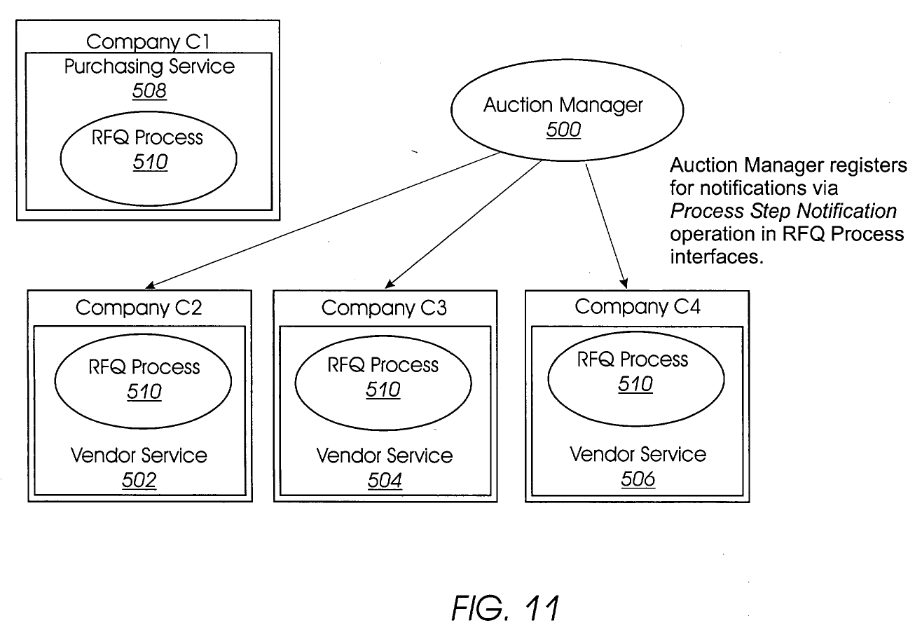

Auction manager 500 then uses the Process Step Completed notification in RFQ process interfaces 522 to register for notification every time a new step is completed, as shown in FIG. 11. In this manner, auction manager 500 can monitor the progress of RFQ process 510. In some embodiments, auction manager 500 utilizes the Invoke Operation in managed object interfaces 524 to invoke the Process Step Completed operations in each instance of RFQ Process 510 with one request.

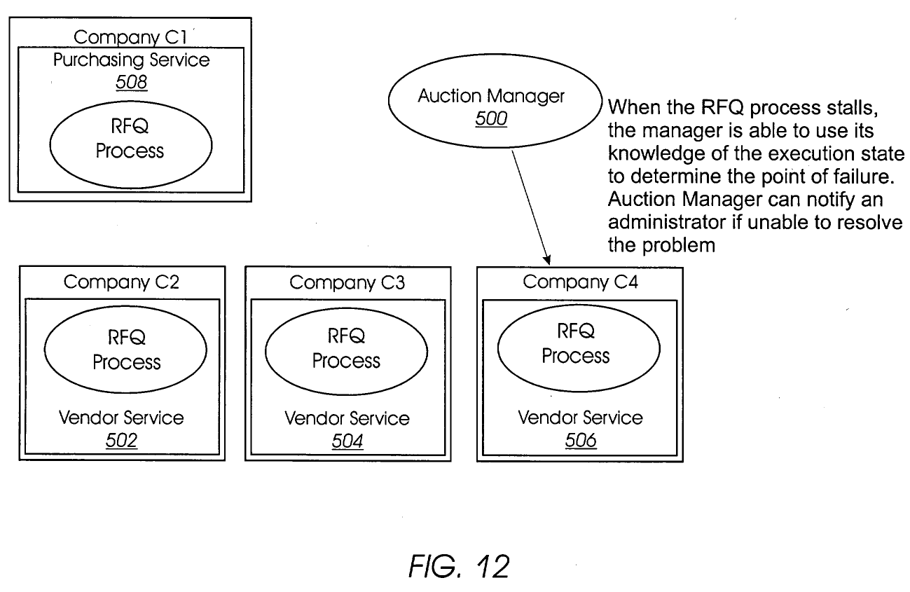

The Process Step Completed notification in RFQ process interfaces 522 continuously updates auction manager 500 as each step in RFQ process 510 is completed for each vendor service 502, 504, 506. Referring to FIG. 12, if RFQ process 510 stalls because, for example, vendor service 506 is not sending a message that is expected, auction manager 500 can determine the cause of the problem using managed object interface 524 for vendor service 506. Auction manager 500 sends a Status request to vendor service 506. When vendor service 506 does not reply within a prespecified time, the problem can be reported to a human operator at auction manager 500. The operator can contact an operator at Company C4 to solve the problem. The transaction can be completed once Company C4 fixes the technical problem.

Referring again to FIG. 2, any type of IT resource can be configured with managed object 108, managed object interfaces 204, event interfaces 202, as well as one or more extended interfaces 206 to allow manager 102 to access management features for the underlying resource(s). While event interfaces 202 and managed object interfaces 204 provide access to a common set of management features that are selectively available for any type of resource based on the access rights of manager 102, extended interfaces 206 can be implemented to provide manager 102 with selective access to any additional management features available for the resource. Further, managed objects 108 can provide a common framework for managing resources both internal and external to an enterprise, and across domains 104, 106.

Components included in manager 102, discovery agencies 114, and managed objects 108 are typically implemented in computer processing systems 214 through 220, respectively. Processing systems 214 through 220 can be any suitable computer-processing device that includes memory for storing and executing logic instructions, and is capable of interfacing with other processing systems. In some embodiments, processing systems 214 through 220 can also communicate with other external components via network (not shown). Various input/output devices, such as keyboard and mouse (not shown), can be included to allow a user to interact with components internal and external to processing systems 214 through 220.

Additionally, processing systems 214 through 220 can be embodied in any suitable computing device, and so include personal data assistants (PDAs), telephones with display areas, network appliances, desktops, laptops, X-window terminals, or other such computing devices. Processing systems 214 through 220 and corresponding logic instructions can be implemented using any suitable combination of hardware, software, and/or firmware, such as microprocessors, Field Programmable Gate Arrays (FPGAs), Application Specific Integrated Circuit (ASICs), or other suitable devices.

Logic instructions executed by processing systems 214 through 220 can be stored on a computer readable medium, or accessed by processing systems 214 through 220 in the form of electronic signals. Processing systems 214 through 220 can be configured to interface with each other, and to connect to external network via suitable communication links such as any one or combination of T1, ISDN, cable line, a wireless connection through a cellular or satellite network, or a local data transport system such as Ethernet or token ring over a local area network.

The Hypertext Transfer Protocol/Secure (HTTPS) is a suitable communication protocol when integrity and/or confidentiality of the SOAP messages is required. When end-to-end security of the SOAP payload is required, WS-Security or other communication protocols may be used. Manager 102 can also authenticate itself to managed objects 108 and vice-versa. Mutual authentication features of HTTPS or other suitable authentication methods can be used.

The types, operations, and attributes disclosed herein are examples of features that can be included in management interfaces 112. Other features can be implemented for management interfaces 112 in addition to, or instead of, the examples of features disclosed herein. Further, the names for the interfaces, attributes, events, operations and other interface features disclosed herein are provided for purposes of illustration only. The same names can be used to represent different features, and other names can be implemented to represent features disclosed herein.

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components have been discussed as separate and discrete components. These components may, however, be combined to form larger or different software modules, logic modules, integrated circuits, or electrical assemblies, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims.

In the claims, unless otherwise indicated the article “a” is to refer to “one or more than one”.

We claim:

1. A system for managing diverse information technology (IT) resources, comprising:
a computer processor; and
a managed object executable on the computer processor, wherein the managed object represents a particular resource;
at least one interface associated with the managed object, wherein the managed object is configured to:
receive a request from a manager;
forward the request to a group of managed objects, wherein the group of managed objects is specified by the request;
gather responses to the request from the group of managed objects;
transmit the responses from the group of managed objects to the manager in a single response; and
the at least one interface is configured to allow the manager to specify a management interface that provides access to a management feature for the resource.

2. The system of claim 1, wherein the at least one interface includes an operation that allows the manager to query the value of an attribute from the group of managed objects.

3. The system of claim 1, wherein the at least one interface includes an operation that allows the manager to modify the value of an attribute in the group of managed objects.

4. The system of claim 1, wherein the at least one interface includes an operation that allows the manager to invoke an operation on the group of managed objects.

5. The system of claim 2, wherein the group of managed objects include management interfaces, and the at least one interface is configured to allow the manager to specify the management interfaces that provide access to the name of the attribute to be modified.

6. The system of claim 3, wherein the group of managed objects include management interfaces, and the at least one interface is configured to allow the manager to specify the management interfaces that provide access to the name of the attribute to be queried.

7. The system of claim 5, wherein the group of managed objects include a management interfaces, and the at least one interface is configured to allow the manager to specify the management interfaces that provide access to the name of an operation to be invoked.

8. The system of claim 1, wherein the at least one interface is configured to allow the manager to specify a subset of the group of managed objects to which to send the request.

9. The system of claim 1, wherein the at least one interface is configured to return fault information that resulted from the request from the group of managed objects.

10. The system of claim 1, wherein the at least one interface is configured to return a list of the group of managed objects to the manager.

11. The system of claim 1, wherein at least one of the group of managed objects is a Web service.

12. A computer product comprising:
at least one managed object executable on a computer processor;
a managed object interface associated with the at least one managed object, wherein the at least one managed object is configured to:
dynamically provide a list of members of a group of managed objects and relationships between the managed objects to a manager via the managed object interface;
issue a request from the manager to selected members of the group of managed objects; and
transmit responses from the selected group of managed objects to the manager in a single response via the managed object interface.

13. The computer product of claim 12, wherein the managed object interface includes an operation that allows the manager to query the value of an attribute from the group of managed objects.

14. The computer product of claim 13, wherein the group of managed objects include a management interface, and the managed object interface is configured to allow the manager to specify the management interface and the name of the attribute in the management interface to be queried.

15. The computer product of claim 12, wherein the managed object interface includes an operation that allows the manager to modify the value of an attribute in the group of managed objects.

16. The computer product of claim 15, wherein the group of managed objects include a management interface, and the managed object interface is configured to allow the manager to specify the management interface and the name of the attribute in the management interface to be modified.

17. The computer product of claim 12, wherein the managed object interface includes an operation that allows the manager to invoke an operation on the group of managed objects.

18. The computer product of claim 17, wherein the group of managed objects include a management interface, and the managed object interface is configured to allow the manager to specify the management interface and the name of an operation in the management interface to be invoked.

19. The computer product of claim 12, wherein the managed object interface is configured to allow the manager to specify a subset of the group of managed objects to which to send the request.

20. The computer product of claim 12, wherein the managed object interface is configured to return fault information that resulted from the request from the group of managed objects.

21. The computer product of claim 12, wherein the managed object interface is configured to return a list of the group of managed objects to the manager.

22. The computer product of claim 12, wherein at least one of the group of managed objects is a Web service.

23. A method for managing an IT resource, comprising:
configuring at least one managed object representing management features of the resource with at least one management interface;
dynamically providing information to a manager regarding the resource including the relationships between the managed object and other managed objects associated with the resource;
receiving a request from a manager to the at least one resource, wherein the request indicates resources selected to receive the request; and
transmitting the request from the at least one resource to the selected resources.

24. The method of claim 23 further comprising:
aggregating responses to the request from the selected resources; and
transmitting the aggregated response to the manager.

25. The method of claim 23, wherein the request indicates an attribute to be queried in the at least one management interface.

26. The method of claim 23, wherein the request indicates an attribute to be modified in the at least one management interface.

27. The method of claim 23, wherein the request indicates an operation to be invoked via the at least one management interface.

28. An apparatus for managing IT resources, comprising:
means for providing a list of managed objects representing the resources, wherein each of the resources can be associated with more than one of the managed objects;
means for providing the types of the managed objects;
means for receiving a request from a manager to one of the resources, wherein the request indicates resources selected to receive the request;
means for transmitting the request to the selected resources;
means for aggregating responses to the request from the selected resources; and
means for transmitting the aggregated response to the manager.
